(19) United States
(12) Patent Application Publication
(10) Pub. No.: US 2006/0152147 A1
(43) Pub. Date: Jul. 13, 2006

(54) Electroluminescent device and method for preparing the same

(76) Inventors: Tae-Woo Lee, Seoul (KR); Sang-Yeol Kim, Gwacheon-si (KR); Jong-Jin Park, Guri-si (KR); Mu-Gyeom Kim, Hwaseong-si (KR); Lyong-Sun Pu, Suwon-si (KR)

Correspondence Address: Robert E. Bushnell, Suite 300, 1522 K Street, N.W., Washington, DC, 20005-1202, US

(21) Appl. No.: 11/287,433

(22) Filed: Nov. 28, 2005

(30) Foreign Application Priority Data
Jan. 7, 2005 (KR) 10-2005-0001670

(51) Int. Cl. H01J 1/62; H01J 63/04

(52) U.S. Cl. 313/504

(57) ABSTRACT

An electroluminescent device comprises a substrate, a first electrode, a second electrode, and an organic layer disposed between the first electrode and the second electrode, and including at least a light-emitting layer. A plurality of metal nano patterns are provided on one surface of at least one of the first electrode and the second electrode. A method of preparing the electroluminescent device comprises providing a substrate, first and second electrodes, and an organic layer including a light-emitting layer, with a plurality of metal nano patterns being provided on at least one of the first and second electrodes. The electroluminescent device can achieve emission of polarized light, regardless of the materials used in forming the organic layer.

### CLAIM OF PRIORITY

This application makes reference to, incorporates the same herein, and claims all benefits accruing under 35 U.S.C. §119 from an application for ELECTROLUMINESCENT DEVICE AND METHOD FOR PREPARING THE SAME earlier filled in the Korean Intellectual Property Office on 7 Jan. 2005 there duly assigned Serial No. 10-2005-0001670.

### BACKGROUND OF THE INVENTION

1. Technical Field

The present invention relates to an electroluminescent device and a method for preparing the same and, more particularly, to an electroluminescent device which can achieve emission of polarized light regardless of materials used to form organic layers, including at least a light-emitting layer, by providing a plurality of metal nano patterns on one surface of at least one of a first electrode and a second electrode, or providing at least one of a first electrode and a second electrode shaped as nano patterns, and a method for preparing the same.

2. Description of the Related Art

An electroluminescent device, specifically, an organic electroluminescent device (organic EL device) is a self-emissive display that emits light by recombination of electrons and holes in a fluorescent or phosphorescent organic layer when a current is applied to the organic layer. Organic EL are lightweight, have simple constituent elements, are easily fabricated, and have superior image quality and a wide viewing angle. In addition, organic EL devices have electrical properties suitable for portable electronic equipment, such as complete creation of moving pictures, high color purity, low power consumption, low voltage driving, and so forth. The organic electroluminescent device can be used in applications in a wide variety of fields, such as display devices, backlight units and the like.

Particularly, research efforts directed at achieving polarized electroluminescence are actively being conducted.

U.S. Pat. No. 6,777,531 B2 discloses polyfluorene, end-capped with at least one charge-transporting moiety, as a material forming an emission layer in an organic electroluminescent device, and devices having the same. In this patent, it is taught that a material for an alignment layer is directly rubbed to achieve polarized electroluminescence.

U.S. Pat. No. 6,649,283 B2 discloses layers comprising polyimide and organic functional material such as hole transport material, electron transport material and/or emitter material, the layers being prepared by mixing the functional material with a polyimide precursor material, forming a thin film out of the mixture, and converting said mixture into doped polyimide. The referenced patent describes a method of obtaining polarized emission which includes rubbing a polyimide-based material and aligning a polymeric liquid crystalline material on the rubbed polyimide-based material.

U.S. Pat. Nos. 6,579,564 B2 and 6,489,044 B1 disclose a layer coated with a friction transferred alignment material so as to have alignment properties, and a device comprising the same. According to these patents, polarized emission is achieved by preparing an alignment layer deposited by a friction transfer method and coating an electroluminescent layer on the alignment layer.

In the conventional electroluminescent devices proposed in the patents discussed above, in order for the proposed devices to emit polarized light, organic layer forming materials need to be converted. However, organic layers are derived from numerous kinds of materials. Thus, it is quite a big challenge to convert such organic layer forming materials into emissive materials. Accordingly, there is a need for development of electroluminescent devices enabling emission of polarized light, regardless of the materials used to form organic layers.

### SUMMARY OF THE INVENTION

Therefore, to solve the foregoing and/or other problems of the related art, the present invention provides an electroluminescent device which can achieve emission of polarized light regardless of the materials used in forming organic layers, including at least a light-emitting layer, by providing a plurality of metal nano patterns on one surface of at least one of a first electrode and a second electrode, or providing at least one of a first electrode and a second electrode shaped as nano patterns, and a method for preparing the same.

According to an aspect of the present invention, an electroluminescent device comprises a substrate, a first electrode, a second electrode, and an organic layer disposed between the first electrode and the second electrode and including at least a light-emitting layer, wherein a plurality of metal nano patterns are provided on one surface of at least one of the first electrode and the second electrode.

According to another aspect of the present invention, an electroluminescent device comprises a substrate, a first electrode, a second electrode, and an organic layer disposed between the first electrode and the second electrode and including at least a light-emitting layer, wherein at least one of the first electrode and the second electrode is shaped as metal nano patterns.

According to still another aspect of the present invention, a method for preparing an electroluminescent device comprises the steps of providing a substrate, forming a first electrode having a plurality of metal nano patterns on the substrate, forming an organic layer including at least a light-emitting layer on the first electrode, and forming a second electrode on the organic layer.

According to yet another aspect of the present invention, a method for preparing an electroluminescent device comprises the steps of providing a substrate, forming a first electrode on the substrate, forming an organic layer including at least a light-emitting layer on the first electrode, and forming a second electrode having a plurality of metal nano patterns on the organic layer.

According to a further aspect of the present invention, a method for preparing an electroluminescent device comprises the steps of providing a substrate, forming a first electrode shaped of metal nano patterns on the substrate, forming an organic layer including at least a light-emitting layer on the first electrode, and forming a second electrode on the organic layer.

According to another aspect of the present invention, a method for preparing an electroluminescent device comprises the steps of providing a substrate, forming a first electrode on the substrate, forming an organic layer including at least a light-emitting layer on the first electrode, and forming a second electrode shaped of metal nano patterns on the organic layer.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIGS. 1 thru 10 schematically illustrate exemplary embodiments of an electroluminescent device configurations of the present invention; and

FIGS. 11 and 12 are graphs showing polarizing performance evaluation data of electroluminescent devices according to the present invention.

### DETAILED DESCRIPTION OF THE INVENTION

Reference will now be made in detail to the preferred embodiments of the present invention, examples of which are illustrated in the accompanying drawings.

An electroluminescent device according to the present invention comprises a substrate, a first electrode, a second electrode, and an organic layer disposed between the first electrode and the second electrode and including at least a light-emitting layer, wherein a plurality of metal nano patterns are provided on one surface of at least one of the first electrode and the second electrode.

The electroluminescent device has a plurality of metal nano patterns provided on one surface of at least one of the first electrode and the second electrode, and enables emission of polarized light based on the reflecting polarizing or transmitting polarizing principle.

In the present invention, the term “metal nano pattern” is used to represent a pattern made of metal and having at least one nano-scale feature dimension, for example, width, height, or the like.

The metal nano patterns are shaped so as to be capable of emitting polarized light. For example, the metal nano patterns are shaped as stripes parallel to each other, and have, but are not limited to, a rectangular or square cross-section.

Each of the metal nano patterns has a width sufficient to impart polarization. The width of the metal nano patterns ranges from 2 nm to 1000 nm, preferably from 10 nm to 700 nm, more preferably from 20 nm to 400 nm. When the width of the metal nano patterns is less than 2 nm, the manufacturing process becomes complicated, resulting in an excessive increase in the manufacturing cost and time. When the width of the metal nano patterns is greater than 1000 nm, satisfactory polarizing effects may not be achievable.

The spacing between two adjacent metal nano patterns ranges from 5 nm to 100 μm, preferably, from 10 nm to 10 μm, more preferably from 20 mn to 1 μm. When the spacing is less than 5 nm, light transmittance is too low, and the manufacturing cost and time may become excessive. When the spacing is greater than 100 μm, satisfactory polarizing effects may not be achievable.

The metal nano patterns may be made of a material capable of reflecting light, for example, a metal. More specifically, the metal nano patterns may be made of at least one material selected from the group consisting of Ag, Cu, Al, Mg, Pt, Pd, Au, Ni, Nd, Ir, Cr, Mg, Cs, Ba, Li, Ca, and alloys of these metals. Particularly, Au is more preferable.

The first electrode and the second electrode may be independently made of at least one material selected from the group consisting of Ag, Mg, Al, Pt, Pd, Au, Ni, Nd, Ir, Cr, Li, Ca, Ba, Cs, Na, Cu, Co, indium tin oxide (ITO), indium zinc oxide (IZO), tin oxide (SnO₂), zinc oxide (ZnO), indium oxide (In₂O₃), and alloys thereof. In addition, the first electrode and the second electrode may be independently made of a conductive polymer. The conductive polymer may be, but is not limited to, polyaniline, poly(3,4-ethylenedioxythiophene) (PEDOT), polypyrrole, or the like.

When the first electrode or the second electrode is used as an anode, it can be made of a material having a high work function, for example, Ag, Al, Pt, Pd, Au, Ni, Nd, Ir, Cr, Cu, Co, ITO, IZO, SnO₂, ZnO, In₂O₃, alloys thereof, polyaniline, PEDOT or polypyrrole. More specifically, when the anode is a transparent electrode, a material having excellent conductivity, such as ITO, IZO, SnO₂, ZnO, In₂O₃, polyaniline, PEDOT or polypyrrole can be used. When the anode is a reflective electrode, the reflective layer is made of Ag, Al, Mg, Pt, Pd, Au, Ni, Nd, Ir, Cr or alloys of these metals, and the transparent electrode layer is then made of ITO, IZO, ZnO, In₂O₃, polyaniline, PEDOT or polypyrrole, which is then laminated on the reflective layer. In addition, various modifications may be effected.

When the first electrode or the second electrode is used as a cathode, it can be made of a material having a small work function so that electrons can be easily supplied to a light-emitting layer among organic layers. For example, the cathode can be made of at least one selected from the group consisting of Li, Ca, Ba, Cs, Na, Mg, Al, and Ag. More specifically, when the second electrode is a transparent electrode used as a cathode, an auxiliary electrode layer or bus electrode lines made of ITO, IZO, ZnO, In₂O₃, polyaniline, PEDOT or polypyrrole may be formed on a thin film made of Li, Ca, Ba, Cs, Na, Ag, Mg, or Al. When the second electrode is a reflective electrode, the cathode may have a double layer structure consisting of a layer made of Li, Ca, Ba, Cs, or Na, and a layer made of Au, Al, Pd, Pt, or Mg. In addition, various modifications may be effected.

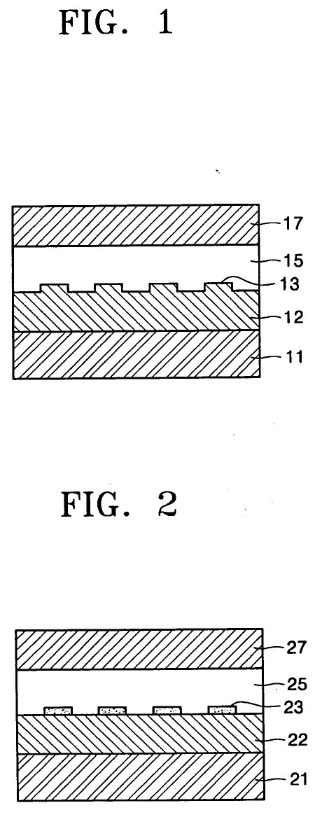

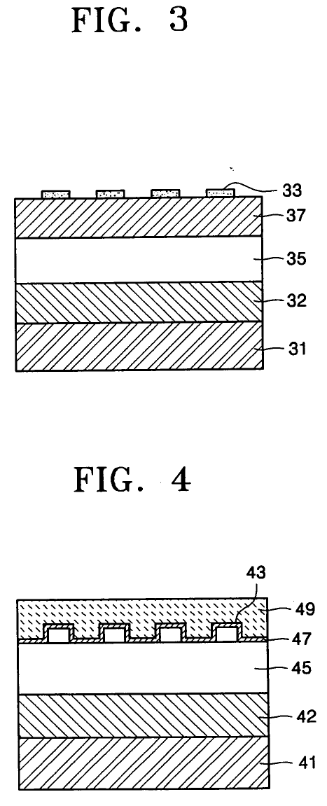

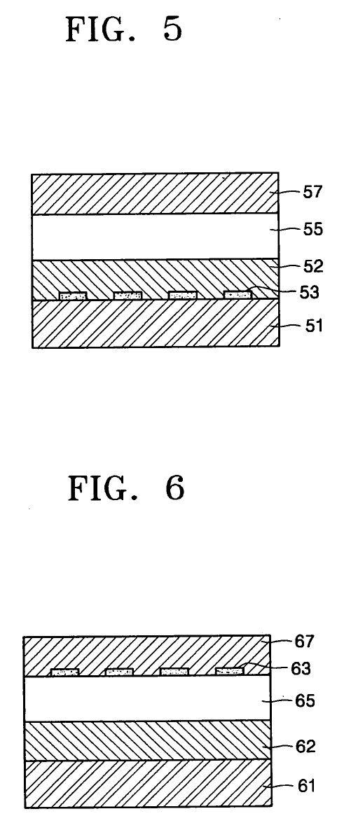

The plurality of metal nano patterns may be integrally provided for the first electrode having the metal nano patterns or the second electrode having the metal nano patterns, as shown in FIGS. 1 and 4, or may be provided discretely from the first electrode having the metal nano patterns or the second electrode having the metal nano patterns, as shown in FIGS. 2, 3, 5 and 6.

The plurality of metal nano patterns may be made of materials the same as or different from materials used to form the first electrode having the metal nano patterns or from materials used to form the second electrode having the metal nano patterns, which depends upon the process of forming the metal nano patterns.

The plurality of metal nano patterns may protrude from the first electrode having the metal nano patterns or from the second electrode having the metal nano patterns, as shown in FIGS. 1, 2, 3 and 4. In addition, the plurality of metal nano patterns may be recessed into the first electrode having the metal nano patterns or into the second electrode having the metal nano patterns, as shown in FIGS. 5 and 6.

In order to emit reflecting polarized light or transmitting polarized light, the plurality of metal nano patterns may be provided at various locations on the electroluminescent device according to the present invention. For example, the plurality of metal nano patterns may be provided between the first electrode and the organic layer. In addition, the plurality of metal nano patterns may be provided on one surface of the second electrode, rather than on the other surface of the second electrode facing the organic layer. Furthermore, the plurality of metal nano patterns may be provided between the first electrode and the substrate, or between the second electrode and the organic layer.

In another embodiment, an electroluminescent device comprises a substrate, a first electrode, a second electrode, and an organic layer disposed between the first electrode and the second electrode and including at least a light-emitting layer, wherein at least one of the first electrode and the second electrode is shaped as metal nano patterns.

In the electroluminescent device according to the illustrative embodiment of the present invention, at least one of the first electrode and the second electrode is shaped as metal nano patterns, thereby enabling emission of polarized light based on the reflecting polarizing or transmitting polarizing principle.

The metal nano patterns are shaped so as to be capable of emitting polarized light. For example, the metal nano patterns are shaped as stripes parallel to each other, and have, but are not limited to, a rectangular or square cross-section.

Each of the metal nano patterns has a width sufficient to impart polarization. The width of the metal nano patterns ranges from 5 nm to 1000 nm, preferably from 10 nm to 700 nm, more preferably, from 50 nm to 400 nm. When the width of the metal nano patterns is less than 5 nm, the manufacturing process becomes complicated, resulting in excessive manufacturing cost and time. When the width of the metal nano patterns is greater than 1000 nm, satisfactory polarizing effects may not be achievable.

The spacing between two adjacent metal nano patterns ranges from 5 nm to 100 μm, preferably, from 10 nm to 10 μm, more preferably from 20 nm to 1 μm. When the spacing is less than 5 nm, light transmittance is too low, and the manufacturing cost and time may become excessive. When the spacing is greater than 100 μm, satisfactory polarizing effects may not be achievable.

At least one of the first electrode and the second electrode may be shaped of metal nano patterns. The first electrode and/or the second electrode shaped of metal nano patterns should be capable of emitting polarized light and serving as electrode(s). Thus, the first electrode and/or the second electrode shaped as metal nano patterns may be made of Ag, Cu, Al, Mg, Pt, Pd, Au, Ni, Nd, Ir, Cr, Mg, Cs, Ba, Li, Ca, Na, Co, or alloys of these metals. A detailed explanation of the first electrode and/or the second electrode not shaped as metal nano patterns is the same as described above in the first aspect of the present invention.

In the electroluminescent device according to the illustrative embodiment of the present invention, the organic layer includes at least a light-emitting layer. In addition to the light-emitting layer, the organic layer may optionally further include at least one selected from the group consisting of a hole injection layer, a hole transport layer, an electron blocking layer, a hole blocking layer, an electron transport layer, and an electron injection layer. The electroluminescent device according to the illustrative embodiment of the present invention may include a substrate, a first electrode, a hole transport layer, a light-emitting layer, an electron injection layer, and a second electrode.

In the electroluminescent device according to the illustrative embodiment of the present invention, materials for forming the organic layer are not particularly limited. This is because the electroluminescent device according to the present invention includes at least one of a first electrode and a second electrode having metal nano patterns provided on one surface thereof, or at least one of a first electrode and a second electrode shaped as metal nano patterns, thereby enabling emission of polarized light. In either case, emission of polarized light can be achieved regardless of the materials used for forming the organic layer.

In another embodiment, a method for preparing an electroluminescent device comprises the steps of providing a substrate, forming a first electrode having a plurality of metal nano patterns on the substrate, forming an organic layer including at least a light-emitting layer on the first electrode, and forming a second electrode on the organic layer.

In another embodiment, a method for preparing an electroluminescent device comprises the steps of providing a substrate, forming a first electrode on the substrate, forming an organic layer including at least a light-emitting layer on the first electrode, and forming a second electrode having a plurality of metal nano patterns on the organic layer.

In another embodiment, a method for preparing an electroluminescent device comprises the steps of providing a substrate, forming a first electrode shaped of metal nano patterns on the substrate, forming an organic layer including at least a light-emitting layer on the first electrode, and forming a second electrode on the organic layer.

In another embodiment, a method for preparing an electroluminescent device comprises the steps of providing a substrate, forming a first electrode on the substrate, forming an organic layer including at least a light-emitting layer on the first electrode, and forming a second electrode shaped of metal nano patterns on the organic layer.

There are a wide variety of methods for forming the metal nano patterns on one surface of the first electrode and/or the second electrode, and methods for forming the first electrode and/or the second electrode shaped as metal nano patterns, and any known nano pattern forming technique can be used. Usable examples of the metal nano pattern forming technique include, but are not limited to, etching, micro contact printing (mCP), nano transfer printing (nTP), nano imprint lithography, cold welding, micro transfer molding, micro molding in capillaries, solvent-assisted micro molding, nano molding, and soft contact lamination.

Exemplary embodiments of the electroluminescent device according to the present invention and a method for preparing the same will now be described in greater detail with reference to FIGS. 1 thru 10. In the electroluminescent devices shown in FIGS. 1 thru 10, materials for forming metal nano patterns, the width of each of the metal nano patterns, the spacing between two adjacent metal nano patterns, materials for forming a first electrode, and materials for forming a second electrode are the same as discussed above.

The electroluminescent device shown in FIG. 1 includes a plurality of metal nano patterns 13 on one surface of a first electrode 12 disposed on a substrate 11, the metal nano patterns 13 being disposed between the first electrode 12 and an organic layer 15.

In detail, the electroluminescent device includes the substrate 11, as shown in FIG. 1. A variety of substrates commonly used for a general electroluminescent device, including a glass substrate, a transparent plastic substrate, and the like, can be used as the substrate 11 in consideration of transparency, surface smoothness, manageability, and waterproofness.

The first electrode 12 having the metal nano patterns 13 is formed on the substrate 11. The metal nano patterns 13 are integrally provided on the first electrode 12. The metal nano patterns 13 are made of the same material as that of the first electrode 12. In addition, the metal nano patterns 13 protrude from the first electrode 12.

An organic layer 15 is provided on the first electrode 12 having the metal nano patterns 13. The organic layer 15 necessarily includes at least a light-emitting layer, and may optionally include at least one selected from the group consisting of a hole injection layer, a hole transport layer, an electron blocking layer, a hole blocking layer, an electron transport layer and an electron injection layer. Any known materials can be used to form the respective layers, and a variety of known deposition or coating techniques can be used to form the respective layers.

Examples of the light-emitting layer of the organic layer 15 include blue emitting materials such as oxadiazole dimer dyes (Bis-DAPOXP), spiro compounds (Spiro-DPVBi, Spiro-6P), triarylamine compounds, bis(styryl)amine (DPVBi, DSA), Flrpic, CzTT, Anthracene, TPB, PPCP, DST, TPA, OXD-4, BBOT, or AZM-Zn; green emitting materials such as Coumarin 6, C545T, Quinacridone), or Ir(ppy)₃; and red emitting materials such as DCM1, DCM2, Eu(thenoyltrifluoroacetone)3 (Eu(TTA)3), or butyl-6-(1,1,7,7,-tetramethyljulolidyl-9-enyl)-4H-pyran (DCJTB). Examples of the high molecular emitting material include, but are not limited to, polymers such as phenylenes, phenylene vinylenes, thiophenes, fluorenes and spiro-fluorenes, and nitrogen-containing aromatic compounds.

A second electrode 17 is provided on the organic layer 15. Materials for forming the second electrode 17 are the same as described above.

After forming the first electrode 12, the metal nano patterns 13 can be formed by any of a variety of nano pattern forming methods as described above. In one embodiment, the metal nano patterns 13 can be formed by a combination of a micro contact printing process and an etching process, which will be described in detail below with reference to FIG. 2.

Like the electroluminescent device shown in FIG. 1, the electroluminescent device shown in FIG. 2 includes a first electrode 22 disposed on a substrate 21, and a plurality of metal nano patterns 23 provided on one surface of the first electrode 22, specifically, between the first electrode 22 and an organic layer 25, the plurality of metal nano patterns 23 being provided discretely from the first electrode 22.

The metal nano patterns 23 may be made of a material different from that of the first electrode 22. For example, the metal nano patterns 23 may be made of Au, and the first electrode 22, which is a transparent electrode, may be made of ITO. The metal nano patterns 23 protrude from the first electrode 22. A detailed explanation of an organic layer 25 and a second electrode 27 is the same as that set forth above with reference to organic layer 15 and second electrode 17 of FIG. 1.

After forming the first electrode 22, the metal nano patterns 23 can be formed by any of a variety of nano pattern forming methods as described above. In one embodiment, the metal nano patterns 23 can be formed by a combination of a micro contact printing process and an etching process.

The micro contact printing process can be used to form a self-assembly monolayer (to be referred to as a “SAM layer” hereinafter) having nano patterns on a thin film made of a material forming the metal nano patterns 23. First, a master formed of a wafer, for example, is prepared. The master, which is used to fabricate a silicon polymer stamp with nano patterns, has a predetermined nano pattern. Then, in order to fabricate the silicon polymer stamp, a silicon polymer forming solution is prepared. The silicon polymer forming solution is commercially available from various chemical companies. For example, Sylgard 184 series available from Dow Chemical, Inc. can be used to prepare the silicon polymer forming solution in order to obtain polydimethylsiloxane (PDMS) as a silicon polymer. The prepared silicon polymer forming solution is poured into the master, followed by curing the silicon polymer forming solution at an appropriate temperature, for example, at 60° C. to 80° C. for PDMS, thereby fabricating a silicon polymer stamp with nano patterns. The silicon polymer stamp is formed so as to contact an SAM layer forming solution by various methods, and is then caused to contact a metal thin film, thereby forming an SAM layer having nano patterns on the thin film.

After forming the SAM layer on a thin film made of a material forming metal nano patterns in the above-described manner, a region of the thin film without the SAM layer is etched, followed by removal of the SAM layer, thereby completing formation of the metal nano patterns 23.

The electroluminescent device shown in FIG. 3 comprises a substrate 31, a first electrode 32, an organic layer 35 and a second electrode 37 sequentially stacked, wherein a plurality of metal nano patterns 33 are provided on one surface of the second electrode 37, specifically on the surface of the second electrode 37 opposite to the surface facing the organic layer 35.

The second electrode 37 may be a transparent electrode, and the plurality of metal nano patterns 33 are provided discretely on the second electrode 37. The metal nano patterns 33 may be made of a material different from that of the second electrode 37. The plurality of metal nano patterns 33 protrude from the second electrode 37. A detailed explanation of the substrate 31 and the organic layer 35 is the same as that of the substrate 11 and organic layer 15 of FIG. 1.

The metal nano patterns 33 can be formed by any of a variety of nano pattern forming methods as described above. In one embodiment, the metal nano patterns 33 can be formed by a method the same as the method of forming the metal nano patterns 23 described above with reference to FIG. 2, except that the metal nano patterns 33 are formed on the second electrode 37.

The electroluminescent device shown in FIG. 4 comprises a substrate 41, a first electrode 42, an organic layer 45, and a second electrode 47 having metal nano patterns 43 formed on a surface of the second electrode 47 other than the surface of the second electrode 47 facing the organic layer 45.

The metal nano patterns 43 are integrally provided for the second electrode 47, and are made of the same material as that of the second electrode 47. The metal nano patterns 43 protrude from the second electrode 47. A detailed explanation of the substrate 41 and the organic layer 45 is the same as that of substrate 11 and organic layer 15 of FIG. 1.

The second electrode 47 having the metal nano patterns 43 can be formed by any of a variety of nano pattern forming methods as described above. In one embodiment, the second electrode 47 having the metal nano patterns 43 can be formed in such a manner that a metal is deposited on the entire surface of a nano-molded soft substrate 49 and is then subjected to soft contact lamination.

In detail, the soft substrate 49 is first provided for forming the second electrode 47 having the metal nano patterns 43. The soft substrate 49 may be a silicon polymer stamp with nano patterns, for example, a PDMS stamp. A detailed explanation of the method for fabricating the stamp is the same as that of the embodiment described above with reference to FIG. 2.

Next, a material forming the metal nano patterns 43, i.e., a material forming the second electrode 47, is deposited on the entire surface of the soft substrate 49 with nano patterns. The deposition technique is not particularly limited to any specific method, and a variety of deposition techniques, including sputtering, e-beam deposition, thermal deposition, and so forth, can be used.

Then, the soft substrate 49, on which the second electrode 47 having the metal nano patterns 43 is formed, is disposed on the organic layer 45. In this respect, an air gap may be created between the metal nano patterns 43 and the organic layer 45, as shown in FIG. 4. The soft substrate 49 can be selectively removed. When the soft substrate 49 is not removed, the soft substrate 49 remains on the second electrode 47 having the metal nano patterns 43, as shown in FIG. 4.

The electroluminescent device shown in FIG. 5 comprises metal nano patterns 53 on one surface of a first electrode 52, specifically, between the first electrode 52 and a substrate 51.

The metal nano patterns 53 are provided discretely from the first electrode 52, and are made of a material different from that of the first electrode 52. The metal nano patterns 53 are recessed into the first electrode 52. A detailed explanation of the substrate 51 and the organic layer 55 is the same as that of the substrate 11 and organic layer 15 of FIG. 1.

The metal nano patterns 53 can be formed by any of a variety of nano pattern forming methods as described above. In one embodiment, the metal nano patterns 53 can be formed by a method the same as the method of forming the metal nano patterns 23 described above with reference to FIG. 2, except that the metal nano patterns 53 are formed on the substrate 51.

The electroluminescent device shown in FIG. 6 comprises a substrate 61, a first electrode 62, an organic layer 65, and a second electrode 67 having metal nano patterns 63, wherein the metal nano patterns 63 are disposed between the second electrode 67 the organic layer 65.

The metal nano patterns 63 are provided discretely on the second electrode 67, and are made of a material different from that of the second electrode 67. The metal nano patterns 63 are recessed into the second electrode 67. A detailed explanation of the substrate 61 and the organic layer 65 is the same as that of the substrate 11 and organic layer 15 of FIG. 1.

After forming the organic layer 65, the metal nano patterns 63 can be formed by any of a variety of nano pattern forming methods as described above. In one embodiment, the metal nano patterns 63 can be formed by a combination of a cold welding process and a soft contact lamination process.

In detail, a material for forming the metal nano patterns 63 is applied to the entire surface of the organic layer 65 to form a thin film (referred to as “A”). Next, a silicon polymer stamp with nano patterns, for example, a PDMS stamp, or a glass stamp with nano patterns, is prepared. A detailed explanation of the process for fabricating the silicon polymer stamp is the same as described above with reference to FIG. 2. The material for forming the metal nano patterns 63 is deposited entirely over the nano patterns of the silicon polymer stamp or the glass stamp, thereby preparing the silicon polymer stamp or glass stamp deposited with material made of the nano patterns (63) (referred to as “B”).

Thereafter, a region “A” and a region “B” of the material for forming the metal nano patterns 63 are brought into contact with each other, and then the stamp is removed. Then, based on the principle of the cold welding process, the region “A” is removed from contact with the region “B” to thus form the metal nano patterns 63 on the organic layer 65. Thereafter, the material for forming the second electrode 67 is applied over the metal nano patterns 63.

The electroluminescent device shown in FIG. 7 comprises a substrate 71, a first electrode 72 shaped as metal nano patterns, an organic layer 75, and a second electrode 77. An exemplary method for forming the first electrode 77 shaped as metal nano patterns is the same as the method for forming the metal nano patterns 63 described above with reference to FIG. 6. The arrangement of FIG. 6, in which the metal nano patterns 63 are formed on the organic layer 65 followed by formation of the second electrode 67, is different from the arrangement of FIG. 7, in which the first electrode 77 functions as both an electrode and metal nano patterns.

The electroluminescent device shown in FIG. 8 comprises a substrate 81, a first electrode 82, an organic layer 85, and a second electrode 87 shaped as metal nano patterns. An exemplary method of forming the second electrode 87 shaped as metal nano patterns is the same as that of forming the metal nano patterns 63 described above with reference to FIG. 6. The arrangement of FIG. 6, in which the metal nano patterns 63 are formed on the organic layer 65 followed by formation of the second electrode 67, is different from the arrangement of FIG. 8, in which the second electrode 87 functions as both an electrode and metal nano patterns.

In a modification of the electroluminescent device shown in FIG. 8, a soft substrate may be provided on the second electrode 87. In this case, a modification of the cold welding process used in forming the electroluminescent device shown in FIG. 6 maybe employed. More specifically, a soft substrate is formed on a flat substrate, for example, a silicon wafer, and the thin film “A” (see FIG. 6) is then formed on the soft substrate, followed by application of the cold welding process used in forming the electroluminescent device shown in FIG. 6, to form the second electrode 87 shaped as metal nano patterns on the soft substrate. The soft substrate having the second electrode 87 shaped as metal nano patterns is laminated on the organic layer 85 by a soft contact lamination process, thereby forming the second electrode 87 shaped as metal nano patterns. When the soft substrate is not removed, an electroluminescent device having the soft substrate provided on the second electrode 87 shaped as metal nano patterns is obtained. This will be described in more detail later through Example 4.

The electroluminescent device shown in FIG. 9 includes a substrate 91, a first electrode 92, an organic layer 95, and a second electrode 97 shaped as metal nano patterns.

After forming the organic layer 95, the second electrode 97 shaped as metal nano patterns can be formed by any of a variety of nano pattern forming methods as described above. In one embodiment of forming the second electrode 97, the second electrode 97 is formed on a flat soft substrate 99, and is then subjected to a soft contact lamination process to allow the second electrode 97 to contact the organic layer 95.

In detail, as the soft substrate 99, a flat base film, for example, a base film made of silicon polymer, is prepared. One example of the silicon polymer is PDMS. A thin film made of the same material as that of the second electrode 97 is formed on one surface of the soft substrate 99, and then the thin film is patterned by a common photoresist patterning technique, thereby forming the second electrode 97 shaped as metal nano patterns on the soft substrate 99. Thereafter, the base film having the second electrode 97 shaped as metal nano patterns provided on its surface is disposed on the organic layer 95. In this regard, due to ductility of the soft substrate 99, the second electrode 97 shaped as metal nano patterns may be recessed into the soft substrate 99, and some region of the substrate 99 and the organic layer 95 may contact each other. In addition, an extremely small air gap (not shown) may be created at a contact portion between the soft substrate 99 and the second electrode 97. The soft substrate 99 may be optionally removed. When the soft substrate 99 is not removed, the soft substrate 99 remains on the second electrode 97, as shown in FIG. 9.

The electroluminescent device shown in FIG. 10 comprises a substrate 101, a first electrode 102, an organic layer 105, and a second electrode 107 shaped as metal nano patterns.

The second electrode 107 can be formed by any of a variety of nano pattern forming methods as described above. In one embodiment, the second electrode 107 can be formed in such a manner that a metal is partially deposited on a surface of a nano-molded soft substrate 109, and is then subjected to soft contact lamination.

In detail, the soft substrate 109 is first provided to form the second electrode 107. The soft substrate 109 may be a silicon polymer stamp with nano patterns, for example, a PDMS stamp. A detailed explanation of the method for fabricating the stamp is the same as that of the embodiment described with reference to FIG. 2.

Next, a material for forming the second electrode 107 is partially deposited on the soft substrate 109 with nano patterns. The deposition technique is not particularly limited, and a variety of deposition techniques, including sputtering, e-beam deposition, thermal deposition, and so on, can be used.

Then, the soft substrate 109 on which the second electrode 107 is formed is disposed on the organic layer 105. In this regard, an air gap 107′ may be created between the second electrode 107 and the organic layer 105, as shown in FIG. 10. The soft substrate 109 can be selectively removed. When the soft substrate 109 is not removed, the soft substrate 109 remains on the second electrode 107, as shown in FIG. 10.

The first electrode 102 and the second electrode 107 can function as an anode and a cathode, respectively, or vice versa. The present invention can be applied to a variety of types of electroluminescent devices. Particularly, when the invention is applied to an active matrix electroluminescent device, the first electrode 102 can be electrically connected to a drain or source electrode of a thin film transistor.

Electroluminescent devices fabricated in accordance with embodiments of the invention may be incorporated into a wide variety of applications, including backlight units of LCDs, and the like.

While the electroluminescent device according to the present invention and the methods of formation thereof have been described by various embodiments, with reference to FIGS. 1 through 10, it is understood that the various embodiments described herein are not intended to limit the scope of the invention. For example, although not illustrated in the drawings, in the case wherein the organic EL device of the present invention is used for bidirectional emission, metal nano patterns maybe provided on both first and second electrodes. Also, various modifications and variations can be made in the present invention.

Hereinafter, the present invention will be described in detail with reference to examples.

### EXAMPLES

### Example 1

To be used as a substrate and a first electrode, a glass substrate and ITO (available from Samsung Corning Co., Ltd.; sheet resistance: 15Ω/cm²; thickness: 1200 Å) were cut into a size of 50 mm×50 mm×0.7 mm and washed in isopropyl alcohol for 5 minutes and in pure water for 5 minutes by ultrasonic waves, and a UV/ozone washing was performed for 30 minutes, thereby preparing an ITO electrode. A thin film of Au was formed on the ITO electrode to a thickness of 20 nm. The thin film of Au was patterned by micro contact printing (mCP) and etching, thereby forming a plurality of Au nano patterns shaped as stripes on the ITO electrode. In this respect, the width of each of the Au nano patterns was 200 nm, and the spacing between two adjacent Au nano patterns was 300 nm. The micro contact printing (mCP) and etching used for forming the Au nano patterns will now be described in more detail.

First, Sylgard 184A and Sylgard 184B (manufactured by Dow Corning Inc.) were mixed in a mixing vessel in a weight ratio of 10:1 to yield a PDMS forming solution. The resultant PDMS forming solution was poured into a master formed as a wafer. The master has stripe-shaped nano patterns. Pores contained in the PDMS forming solution in the master were removed using a vacuum pump, the PDMS forming solution was then cured in an oven at a temperature of 60° C. to 80° C., and the master was removed, thereby obtaining a PDMS stamp. Observed results indicated that nano patterns formed in the PDMS stamp had the same width and spacing as those of Au nano patterns to be fabricated later.

Thereafter, alkane thiolate powder was mixed with ethanol to give a 3 mM solution for use as a self-assembled monolayer (SAM) forming solution, followed by immersing the PDMS stamp in the SAM solution. The resultant PDMS stamp, coated with the SAM forming solution, was brought into contact with the thin film of Au, thereby forming an SAM layer having the same patterns as the Au nano patterns on the thin film of Au.

Then, Au present in a region other than the SAM layer was etched in a ferriferrocyanide etching bath containing 1 mM K₄Fe(CN)₆, 10 mM K₃Fe(CN)₆, 0.1 M Na₂S₂O₃, and 1.0 M KOH to then remove the SAM layer, thereby obtaining the ITO electrode with Au nano patterns having a width and a spacing between patterns according to the present invention.

Poly(9,9-dioctylfluorene-co-bis-N,N′-(4-butylphenyl)-bis-N,N′-phenyl-1,4-phenylenediamine as a hole transport material (PFB manufactured by Dow Chemical Co., Ltd.) was spin-coated on the ITO electrode with the Au nano patterns to form a 10 nm thick hole transport layer. A light-emitting layer having a thickness of 70 nm was formed on the hole transport layer using spirofluorene-based emitting polymer as a blue emitting material. BaF₂ was deposited on the light-emitting layer to form an electron injection layer having a thickness of 4 nm. Ca was deposited on the resultant structure to a thickness of 2.7 nm and Al was then deposited thereon to a thickness of 250 nm to form a second electrode on the electron injection layer. The electroluminescent device shown in FIG. 2 was completed, which is referred to as sample 1.

### Example 2

To be used as a substrate and a first electrode, a glass substrate and ITO (available from Samsung Corning Co., Ltd.; sheet resistance: 15 Ω/cm²; thickness: 1200 Å) were cut into a size of 50 mm×50 mm×0.7 mm and washed in isopropyl alcohol for 5 minutes and in pure water for 5 minutes by ultrasonic waves, and a UV/ozone washing was performed for 30 minutes. A light-emitting layer made of MEH-PPV (poly[2-methoxy-5-(2-ethylhexyloxy)-1,4-phenylenevinylene]) as a red emitting material and having a thickness of 70 nm was formed on the ITO electrode. A second electrode (cathode) shaped as metal nano patterns was manufactured in the following manner by soft contact lamination.

First, Sylgard 184A and Sylgard 184B (manufactured by Dow Corning Inc.) were mixed in a mixing vessel in a weight ratio of 10:1 to yield a PDMS forming solution. The resultant PDMS forming solution poured into a master formed as a wafer. The master has stripe-shaped nano patterns. Pores contained in the PDMS forming solution in the master were removed using a vacuum pump, the PDMS forming solution was then cured in an oven at a temperature of 60° C. to 80° C., and the master was removed, thereby obtaining a PDMS stamp.

Thereafter, Au was deposited on an entire surface of the PDMS stamp to form a thin film of Au having a thickness of 20 nm and patterned according to the nano patterns provided in the PDMS stamp. The thin film of Au had nano patterns of 300 nm in width and 300 nm in spacing between two adjacent patterns.

Thereafter, the thin film of Au having nano patterns was brought into contact with the light-emitting layer to form an Au electrode having Au nano patterns, thereby completing the electroluminescent device shown in FIG. 4, which is referred to as sample 2.

### Example 3

To be used as a substrate and a first electrode, a glass substrate and ITO (available from Samsung Corning Co., Ltd.; sheet resistance: 15 Ω/cm²; thickness: 1200 Å) were cut into a size of 50 mm×50 mm×0.7 mm and washed in isopropyl alcohol for 5 minutes and in pure water for 5 minutes by ultrasonic waves, and a UV/ozone washing was performed for 30 minutes. A light-emitting layer made of MEH-PPV (poly[2-methoxy-5-(2-ethylhexyloxy)-1,4-phenylenevinylene]) as a red emitting material having a thickness of 70 nm was formed on the ITO electrode. A second electrode (cathode) shaped as metal nano patterns was manufactured in the following manner using cold welding and soft contact lamination.

First, Au was deposited on an entire surface of the light-emitting layer. Then, Sylgard 184A and Sylgard 184B (manufactured by Dow Corning Inc.) were mixed in a mixing vessel in a weight ratio of 10:1 to yield a PDMS forming solution. Meanwhile, a master shaped as nano patterns (stripes) was prepared. The nano pattern master was provided on a silicon wafer. The nano pattern had a width of 50 nm and a spacing of 50 nm. The PDMS forming solution was poured into the master shaped as nano patterns (stripes). Thereafter, pores contained in the PDMS forming solution in the master were removed using a vacuum pump, the PDMS forming solution was then cured in an oven at a temperature of 60° C. to 80° C., and the master was removed, thereby obtaining a PDMS stamp with nano patterns. The nano patterns formed in the PDMS stamp had a width of 50 nm and a spacing of 50 nm.

Thereafter, Ti was deposited on the PDMS stamp to a thickness of 2 nm, and Au was entirely deposited thereon. The resultant structure was brought into contact with the Au thin film deposited on the entire surface of the light-emitting layer. Then, the PDMS stamp was removed to form an Au electrode shaped as nano patterns (stripes) on the organic layer based on the principle of the cold welding process. The Au electrode shaped as nano patterns had a width of 50 nm and a spacing of 50 nm. Therefore, the electroluminescent device shown in FIG. 8 was completed and referred to as sample 3.

### Example 4

To be used as a substrate and a first electrode, a glass substrate and ITO (available from Samsung Corning Co., Ltd.; sheet resistance: 15 Ω/cm2; thickness: 1200 Å) were cut into a size of 50 mm×50 mm×0.7 mm and washed in isopropyl alcohol for 5 minutes and in pure water for 5 minutes by ultrasonic waves, and a UV/ozone washing was performed for 30 minutes. A light-emitting layer made of MEH-PPV (poly[2-methoxy-5-(2-ethylhexyloxy)-1,4-phenylenevinylene]) as a red emitting material and having a thickness of 70 nm was formed on the ITO electrode. A second electrode (cathode) shaped as metal nano patterns was manufactured in the following manner using cold welding and soft contact lamination.

First, Sylgard 184A and Sylgard 184B (manufactured by Dow Corning Inc.) were mixed in a mixing vessel in a weight ratio of 10:1 to yield a PDMS forming solution. Meanwhile, a plain silicon wafer without patterns and a stripe-shaped nano pattern master were prepared. The nano patterns formed in the nano pattern master had a width of 50 nm and a spacing of 50 nm. The PDMS forming solution was poured into the plain silicon wafer and the nano pattern master, respectively. Thereafter, pores contained in the PDMS forming solution in the master were removed using a vacuum pump, the PDMS forming solution was then cured in an oven at a temperature of 60° C. to 80° C., and the master and the silicon wafer were removed, thereby obtaining a plain PDMS stamp without patterns and a PDMS stamp having stripe-shaped nano patterns, respectively. The nano patterns formed in the PDMS stamp having stripe-shaped nano patterns had a width of 50 nm and a spacing of 50 nm.

Next, Au was entirely deposited on the plain PDMS stamp without patterns. Then, Ti was entirely deposited on the PDMS stamp having stripe-shaped nano patterns to a thickness of 2 nm and Au. The resultant PDMS stamps were adhered to each other, thereby forming an Au electrode shaped as nano patterns (stripes) on the plain PDMS stamp based on the principle of the cold welding process. The Au electrode shaped as nano patterns (stripes) had a width of 50 nm and a spacing of 50 nm.

Thereafter, the PDMS stamp having the Au electrode shaped as nano patterns was brought into contact with the light-emitting layer, thereby completing the electroluminescent device having an Au electrode shaped as nano patterns, as described in the modification of the EL device shown in FIG. 8, which is referred to as sample 4.

### Evaluation Example

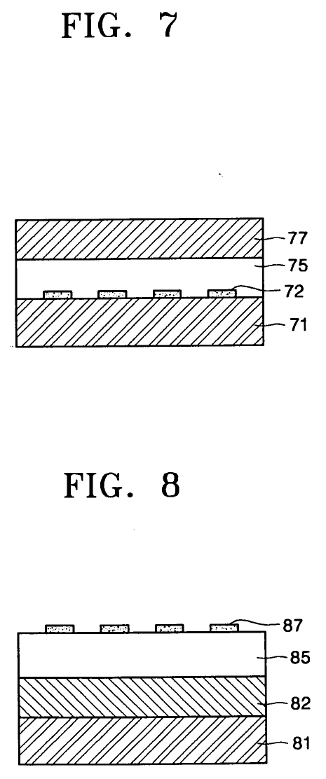

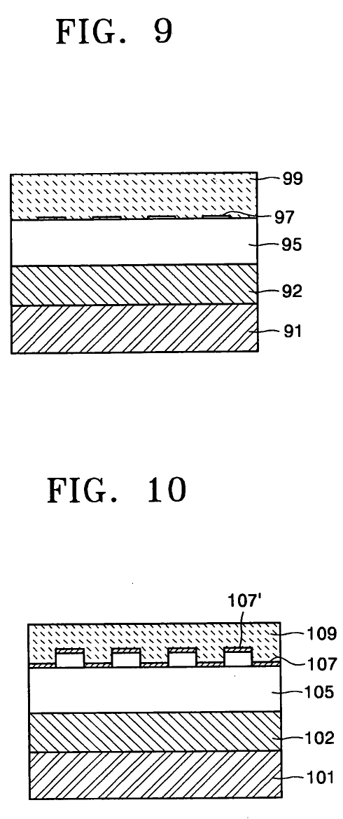

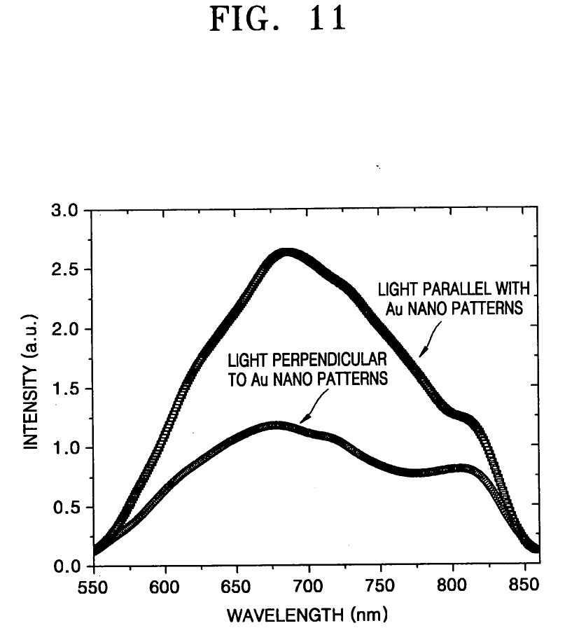

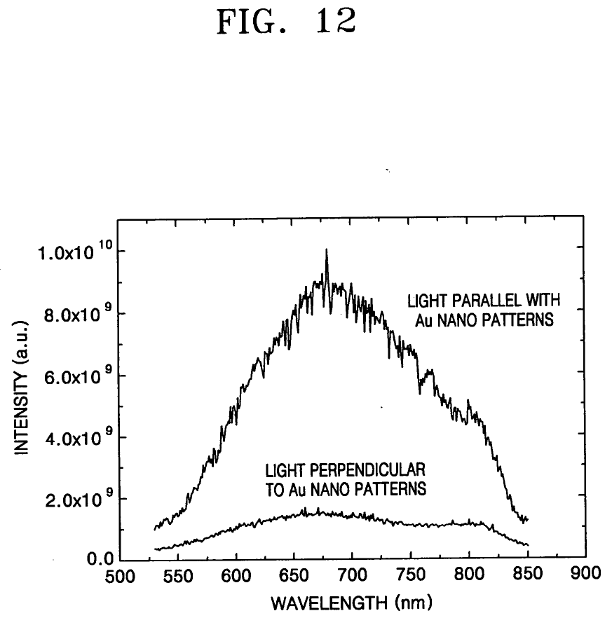

To evaluate polarizing performance, photoluminescent intensities of the samples 1 and 2 were measured, and the results thereof are shown in FIGS. 11 and 12, respectively. The polarizing performance was evaluated using a photoluminescence spectroscopic device having a polarizing film.

Referring to FIG. 11, it was found that the light intensity of light parallel to the Au nano patterns was higher than that of light perpendicular to the Au nano patterns. Particularly, the light parallel to the Au nano patterns of the sample 2 was approximately 2.5 times the light perpendicular to the Au nano patterns around 670 nm.

Referring to FIG. 12, it was found that the intensity of light parallel to the Au nano patterns was higher than that of light perpendicular to the Au nano patterns. Particularly, the light parallel to the Au nano patterns of the sample 2 was approximately 6 times the light perpendicular to the Au nano patterns around 670 nm.

As described above, in the electroluminescent device according to the present invention, since a plurality of metal nano patterns are provided on at least one of a first electrode and a second electrode, or at least one of the first electrode and the second electrode are shaped of metal nano patterns, emission of polarized light can be achieved regardless of the materials used to form an organic layer.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. An electroluminescent device, comprising:
a substrate;
a first electrode;
a second electrode; and
an organic layer disposed between the first electrode and the second electrode, and including at least a light-emitting layer, wherein a plurality of metal nano patterns are provided on one surface of at least one of the first electrode and the second electrode.

2. The electroluminescent device of claim 1, wherein the metal nano patterns are shaped as stripes which are arranged in parallel with each other, and have one of a rectangular cross-section and a square cross-section.

3. The electroluminescent device of claim 1, wherein each of the metal nano patterns has a width in a range of 2 nm to 1000 nm.

4. The electroluminescent device of claim 1, wherein a spacing between the metal nano patterns is in a range of 5 nm to 100 μm.

5. The electroluminescent device of claim 1, wherein the metal nano patterns are made of at least one material selected from a group consisting of Ag, Cu, Al, Mg, Pt, Pd, Au, Ni, Nd, Ir, Cr, Mg, Cs, Ba, Li, Ca, and alloys thereof.

6. The electroluminescent device of claim 1, wherein the first electrode and the second electrode are independently made of one of at least one material selected from a group consisting of Ag, Mg, Al, Pt, Pd, Au, Ni, Nd, Ir, Cr, Li, Ca, Ba, Cs, Na, Cu, Co, ITO, IZO, SnO₂, ZnO, In₂O₃, and alloys thereof, and at least one conductive polymer selected from a group consisting of polyaniline, poly(3,4-ethylenedioxythiophene) (PEDOT), and polypyrrole.

7. The electroluminescent device of claim 1, wherein the plurality of metal nano patterns are integrally provided for one of the first electrode having the metal nano patterns and the second electrode having the metal nano patterns.

8. The electroluminescent device of claim 1, wherein the plurality of metal nano patterns are provided discretely from one of the first electrode and the second electrode having the metal nano patterns.

9. The electroluminescent device of claim 1, wherein the plurality of metal nano patterns are made of materials the same as materials provided for one of the first electrode having the metal nano patterns and the second electrode having the metal nano patterns.

10. The electroluminescent device of claim 1, wherein the plurality of metal nano patterns are made of materials different from materials provided for one of the first electrode having the metal nano patterns and the second electrode having the metal nano patterns.

11. The electroluminescent device of claim 1, wherein the plurality of metal nano patterns protrude from one of the first electrode and the second electrode having the metal nano patterns.

12. The electroluminescent device of claim 1, wherein the plurality of metal nano patterns are recessed into one of the first electrode and the second electrode having the metal nano patterns.

13. The electroluminescent device of claim 1, wherein the plurality of metal nano patterns are provided between the first electrode and the organic layer.

14. The electroluminescent device of claim 1, wherein the plurality of metal nano patterns are provided on a surface of the second electrode which does not face the organic layer.

15. The electroluminescent device of claim 1, wherein the plurality of metal nano patterns are provided between the first electrode and the substrate.

16. The electroluminescent device of claim 1, wherein the plurality of metal nano patterns are provided between the second electrode and the organic layer.

17. An electroluminescent device, comprising:
a substrate;
a first electrode;
a second electrode; and
an organic layer disposed between the first electrode and the second electrode, and including at least a light-emitting layer, wherein at least one of the first electrode and the second electrode is shaped as metal nano patterns.

18. The electroluminescent device of claim 17, wherein the metal nano patterns are shaped as stripes which are arranged in parallel with each other, and have one of a rectangular cross-section and a square cross-section.

19. The electroluminescent device of claim 17, wherein each of the metal nano patterns has a width in a range of 2 nm to 1000 nm.

20. The electroluminescent device of claim 17, wherein a spacing between the metal nano patterns in a range of 5 nm to 100 μm.

21. The electroluminescent device of claim 17, wherein the first electrode and the second electrode are independently made of one of at least one material selected from a group consisting of Ag, Mg, Al, Pt, Pd, Au, Ni, Nd, Ir, Cr, Li, Ca, Ba, Cs, Na, Cu, Co, ITO, IZO, SnO₂, ZnO, In₂O₃, and alloys thereof, and at least one conductive polymer selected from a group consisting of polyaniline, poly(3,4-ethylenedioxythiophene) (PEDOT), and polypyrrole.
